(19) United States
(12) Patent Application Publication
(10) Pub. No.: US 2010/0133340 A1
(43) Pub. Date: Jun. 3, 2010

(54) SYSTEM AND METHOD FOR USE OF LOTTERY TERMINALS AS ELECTRONIC VOTING MECHANISMS

(75) Inventor: WILLIAM J. HUNTLEY, CUMMING, GA (US)

Correspondence Address: DORITY & MANNING, P.A., POST OFFICE BOX 1449, GREENVILLE, SC, 29602-1449, US

(73) Assignee: SCIENTIFIC GAMES INTERNATIONAL, INC., NEWARK, DE (US)

(21) Appl. No.: 12/627,465

(22) Filed: Nov. 30, 2009

Related U.S. Application Data
(60) Provisional application No. 61/119,456, filed on Dec. 3, 2008.

(51) Int. Cl. G06K 17/00

(52) U.S. Cl. 235/386

(57) ABSTRACT

A system and method for conducting elections using a networked system of lottery terminal units involves outfitting terminal units with peripheral devices configured to receive voting input from a user. Ballot scanners and/or control panels receive voter identification and selection information, while cameras, biometric sensors, card readers or other devices obtain additional identification information for verification of voter identity. Voter selections are provided as output to a user via a printed receipt or screenshot for obtaining confirmation or optional designation of changed selections. Storage areas for physically storing voter ballots, incorrect receipts, etc. may be provided. Processing features associated with a terminal unit controller execute software instructions programming the controller to selectively store and/or electronically communicate data corresponding to voter information and selections to one or more central remote locations, such as designated based on voting jurisdictions.

### PRIORITY CLAIM

The present application claims priority to U.S. Provisional Application Ser. No. 61/119,456, filed Dec. 3, 2008.

### FIELD OF THE INVENTION

The present invention relates to a method and related system for conducting electronic voting using networked lottery terminals, and more particularly to accurate and secure compilation of voting and ballot information across selected jurisdictions using a lottery system.

### BACKGROUND

Most jurisdictions lack a permanent infrastructure for coordinating the process of voting for elected officials and related political issues. When election times periodically arrive, poling locations are usually set up at schools, community buildings, etc. that are not normally outfitted with the system infrastructure or voting mechanisms to handle receipt of voter ballots. Since the location of voting sites is often limited to a handful of locations within a given jurisdiction, such locations often experience long lines of voters, resulting in an inconvenient and inefficient voting process.

Conventional voting mechanisms used in large-scale election events can be cumbersome and inaccurate. Despite a relatively recent transition from paper ballots to electronic voting systems, disputes still arise as to the accuracy of a voter's selections. Such issues have been especially prevalent with voting mechanisms that accommodate punch cards or the like. Validity issues also remain as to the authorization of registered voters.

Presently known electronic voting mechanisms are not configured for wide area gathering of ballot information across a given jurisdiction or jurisdictions, such as on the local, county, state and national levels. In contrast, presently known electronic voting systems collect votes received at a particular location and keep them locally, as opposed to electronically communicating tabulated results in real time to a mainframe or other centralized location.

In light of the various issues and others related to conventional voting technologies, the importance of having an efficient and accurate voting process is realized. The present invention addresses such issues and others by providing an improved voting system and method that uses lottery terminals. Additional details of the invention will be appreciated after reading the remainder of the specification, including the claims and drawings.

### SUMMARY

Objects and advantages of the invention will be set forth in part in the following description, or may be obvious from the description, or may be learned through practice of the invention.

Exemplary embodiments of the subject invention utilize lottery terminal units and networked configurations thereof to coordinate a secure and accurate voting process. Utilization of lottery terminals provides many advantages, including the ability to coordinate large numbers of voting transactions at a given time. No transactions are lost and the voting transactions remain essentially flawless in terms of accuracy, thus providing further distinct advantages over conventional voting mechanisms. Data is not only more accurate, but can be more easily compiled across one or more wide areas by relayed communications in real time. Cost advantages are also achieved, since the government entities or others usually tasked with overseeing the voting process often already own, lease, or otherwise have ready access to lottery terminal assets. As such, a voting system can be implemented more cost-efficiently using lottery terminals without having to purchase additional, expensive voting structures.

Various exemplary aspects of the invention may relate to methods and steps for using a lottery terminal as an electronic voting mechanism. Initial steps of such a method relate to voter registration and provision of ballots to registered voters. Ballots are provided in a form that is compatible with a lottery terminal unit, such that the terminal can scan and read information associated with the ballot. For example, the lottery terminal unit may be configured to gather such information from the ballot as a unique voter identification variable and selection choices for various voting items, such as selection for elected national, state and/or local officials, constitutional amendments, local referendums, certified questions, and other items.

The information contained on the ballots, as well as other information, is provided as input to a lottery terminal unit. For example, ballots may be provided to an input scanner capable of detecting user selections from the ballots and correlating that information to electronic data for subsequent storage and relay. Voter selections may alternatively by provided by manual selection at a control panel or touch-screen associated with the terminal unit. Voter identification information in the form of unique ID numbers, bar codes, etc. may also be provided on a ballot as input to the terminal unit. Additional identification information may be provided via such peripheral devices as a camera/webcam, biometric sensor or card reader. In some embodiments, input from an entity authorized to verify voter identity is also provided to the terminal unit at some point before, during or after the voting transaction.

All or some of the information obtained from a voter via the lottery terminal unit may be subsequently provided as output so that a voter can confirm his/her selections. For example, a screen may visually display the voter selections to a user. Alternatively, a receipt or other paper identifying voter selections may be printed for a user. A user can then review the information and confirm his/her selections, or use a control panel to change his/her selections before confirming them. The confirmed information is processed into electronic form (as data or signals) which can be stored locally at the terminal unit, or relayed to and stored at one or more separate locations. For example, voter identification and selection information may be sent to one or more central locations coordinated by the respective jurisdiction on the national, state, county, town, local and/or other level.

Various additional aspects of the invention are related to a lottery terminal unit and associated system components that are provided for selectively operating the terminal unit as a voting mechanism. For example, a lottery terminal may include such exemplary components as an input device, a terminal controller (including at least one processor and memory element), an output device and a network interface. The input device may correspond to one or more of a ballot scanner, control panel, touch screen, card reader, etc. to obtain information representative of initial voting data (e.g., voter identification and selections) from the user. The output device may correspond to a printer or a display screen for providing visual information to a user. Computer-readable software instructions are stored in the terminal controller memory and executed by the terminal controller processor such that the terminal controller is programmed to process the initial voting data received from the user and store it locally or externally as electronic data. Additional software instructions may be executed to program the terminal controller to electronically communicate all or selected portions of the received information to one or more central locations via the network interface, which is connected to a network such as but not limited to the Internet, a WAN or a LAN.

In accordance with still further aspects of the present invention, a networked configuration of multiple lottery terminal units may be linked across a given area or areas to track and coordinate aspects of the voting system in the area(s). For example, all terminal units within a state (or county, or other defined area) may be networked to coordinate such issues as issued ballots, voter selection options, issued unique identification numbers, etc. The lottery terminal units may be communicatively coupled (via direct or indirect connection) to one or more central host computers with control features configured to manage, execute and control various aspects of the election system and related features and processes.

Additional aspects of the methodology and system are discussed in greater detail below by reference to particular non-limiting embodiments illustrated in the drawing.

### BRIEF DESCRIPTION OF THE DRAWINGS

FIG. 1 is a block diagram of an exemplary embodiment of a networked lottery system that may be employed in accordance with a voting system and method of the present invention;

FIG. 2 is a block diagram of exemplary electronic components of a lottery terminal unit as shown in FIG. 1, whereby features for using the terminal unit as a voting mechanism are provided;

FIG. 3 is a perspective view of a front side of an exemplary voter ballot that may be used in a voting system and methodology of the present invention; and

FIG. 4 is a flow chart of exemplary steps that may be associated with a method of conducting elections using a networked collection of lottery terminal units.

### DETAILED DESCRIPTION

Reference will now be made in detail to embodiments of the inventive methods and systems, one or more examples of which are illustrated in the drawings. Each embodiment is presented by way of explanation of the invention, and not as a limitation of the invention. For example, features illustrated or described as part of one embodiment may be used with another embodiment to yield still a further embodiment. It is intended that the present invention include these and other modifications and variations as come within the scope and spirit of the invention.

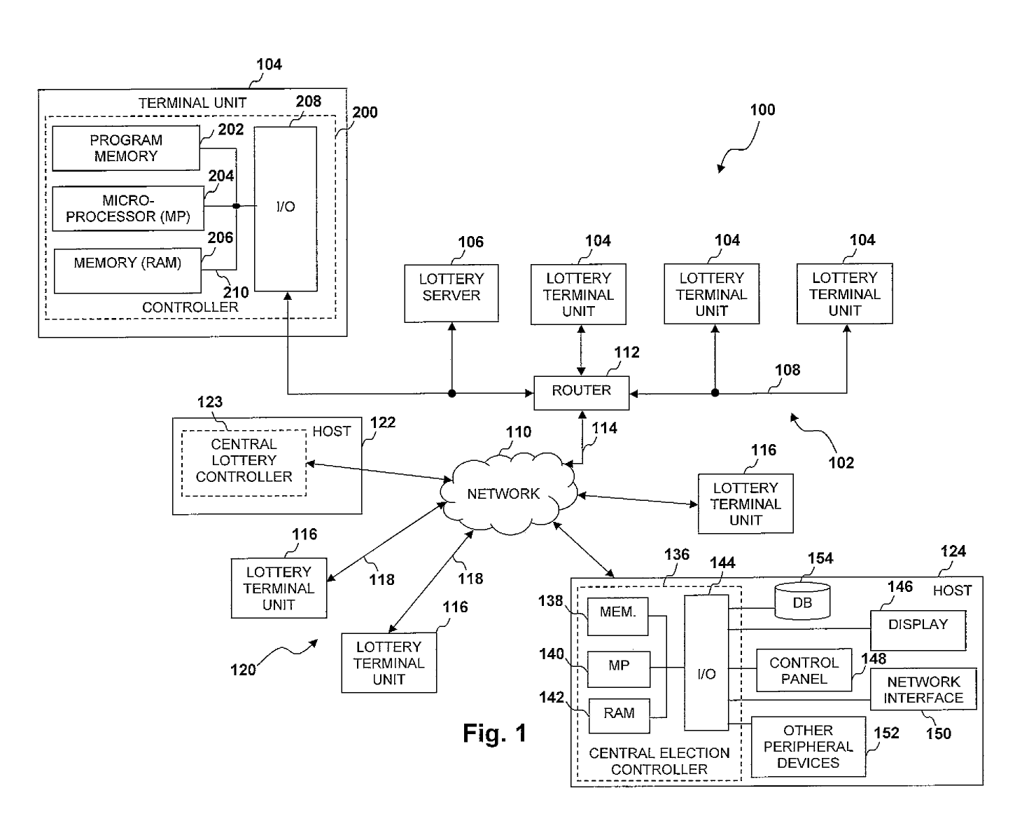

FIG. 1 illustrates one possible embodiment of a lottery network 100 that may be configured for use as an election network with communicatively coupled terminal units functioning as voting mechanisms. Although the network, terminal units and other components thereof may be discussed herein as “lottery” or “gaming” components, it should be appreciated that when used in the context of the present invention, such components are temporarily reconfigured or “toggled” to operate in whole or in part as election or voting components. The discussion herein focuses on the use of such terminal units as voting mechanisms. Additional discussion of how terminal units may function as gaming mechanisms is provided in U.S. Pat. No. 7,134,959 (Penrice) and U.S. Pat. No. 7,204,756 (Jubinville et al.), both of which are incorporated herein by reference for all purposes.

Referring now to FIG. 1, the lottery network 100 may include a first group or network 102 of lottery terminal units 104 operatively coupled to a lottery network computer or server 106 via a network data link or bus 108. The lottery network 100 may be coupled to a network 110, which may be, for example, the Internet, a wide area network (WAN), or a local area network (LAN) through a network hub or router 112 via a first network link 114. In one possible configuration, the first network 102 may be a state lottery system operating within an individual state or region of states. In this configuration, the individual lottery terminal units 104 may be interconnected to a central system (e.g., host computer system 122) for tracking and coordination of the state lottery system, including issued tickets, drawn numbers, and/or amounts waged.

The lottery network 100 may further include other lottery terminal units 116 that may be directly connected to the network 110 through a plurality of direct network links 118, thereby eliminating the need for the bus 108, router 112 or other networking equipment. Each lottery terminal unit 116 in this configuration may represent a group of lottery retailers participating in the state lottery, as described above, or a plurality of the lottery terminal units 116 may be grouped together to form a lottery node 120. The lottery nodes 120, in turn, may be directly connected and/or multiplexed to the network 110 via the direct network links 118. Further, the direct network links 118 may represent secure communications channels physically hardened against tampering and/or the communications may be encrypted to prevent unauthorized access to information transmitted thereon.

As mentioned above, aspects of the present technology are concerned with employing lottery terminal units as voting mechanisms. As such, the terminal units (which are also capable of use for gaming or lottery applications) are outfitted with specialized features which enable their use also as voting mechanisms. In one example, all lottery terminal units may be used as voting mechanisms. In another example, only a subset of selected or enabled lottery terminal units are designated for authorized use as lottery terminal units. It may be desirable to limit the number of terminal units employed as voting mechanisms to assist with security issues, while realizing that increased availability of terminal units can increase convenience to voters. As such, any desired balance between convenience and security issues as achieved by selecting which terminal units to employ as voting mechanisms is within the purview of this invention, and should not be unnecessarily limiting to the invention.

In one exemplary embodiment, voting information entered by users of the terminal units may be relayed to a central location via network 110. For example, selected information including but not limited to one or more of voter selections, unique voter identification information, and other variables may be relayed at various times. In one embodiment, such information gathered by respective terminal units is relayed periodically. In another embodiment, such information is relayed automatically as it is entered and/or confirmed by a user, thus affording real-time access to, monitoring of and analysis of voting input data. Such real-time availability of voting data may provide for advantageous analysis including reports of running vote totals and the like. In one embodiment, voting data is relayed to a central location corresponding to a host computer 122, which generally includes a central lottery controller 123 for controlling aspects of a lottery or gaming system. Just as such a central lottery controller can effectively coordinate issued tickets, drawn numbers, etc. associated with lottery or other gaming tickets, the same central system can coordinate such election matters as issued ballots, unique voter identification, voter selections, and the like.

In another example, one or more separate host computer systems 124 may be provided in addition to the central host computer 122 (with central lottery controller 123) to coordinate, track and process election information separately from gaming or lottery information. For example, host computer system 124 may correspond to a processing system at a designated election headquarters or other authorized facility. More than one central election system (such as represented by systems 122 or 124 in FIG. 1) may be configured to receive selected information. Multiple central election systems could receive the same information. Alternatively, a first predetermined location could receive some of the election information, while a second predetermined location could receive other portions of the election information. Third, fourth, etc. central systems could additionally be configured for receiving vote information. Different centralized locations could be especially useful for coordinating the election information at different jurisdictional levels. For example, election information about voter selections received for national offices and/or national issues can be sent to a centralized location for national information. Selection information about voter selections received for state offices or and or state issues (for example, proposed state constitutional amendments, statewide referendums, and others) can be sent to a centralized location for state information. Finally, voter selections received for local offices, local issues, etc. can be sent to other locations as designated on the county, town, municipal or other local level.

Additional exemplary aspects of a central election host computer system 124 will now be discussed. The host computer system 124 may be a single networked computer, or a series of interconnected computers having access to the network 110 via a gateway or other known networking system. Generally, the central host computer 134 may include a central controller 136 configured to manage, execute and control the individual terminal units 104, 116 and 120 and the routines used to implement voting at the terminals. If the same central system is used to coordinate gaming procedures and voting procedures, then joint management and execution of such procedures can be coordinated. The central controller 136 may include a memory 138 for storing voting procedures and routines, a microprocessor (MP) 140 for executing the stored programs, a random access memory (RAM) 142 and an input/output (I/O) bus 144. The memory 138, microprocessor 140, RAM 142 and the I/O bus 144 may be multiplexed together via a common bus, as shown, or may each be directly connected via dedicated communications lines, depending on the needs of the system 100.

With further reference to FIG. 1, the central controller 136 may be directly connected, hardwired, or indirectly connected through the I/O bus 144 to external components such as a display 146, a control panel 148, a network interface device 150 and other peripheral I/O devices 152. Examples of other peripherals device include, but are not limited to, storage devices, wireless adaptors, printers, and the like. In addition, a database (DB) 154 may be communicatively connected to the central controller 136 and provide a data repository for the storage and correlation of information gathered from the individual terminal units 104, 116 or nodes 120. The information stored within the database 154 may be information relating to individual terminal units 104, 116 such as terminal specific information like a terminal identification code, voting authority code, and location for each ballot received. The database 154 may further include voter and/or ballot specific information such as the officials or issues selected for vote, voter selections made, presence of any errors or changes made, voter identification information including unique voter identification variable, digital image, biometric sensor information, etc.

In operation, the central controller 136 may operate as a clearing-house for the terminal units 116 and the first network 102, whereby the lottery network computer 106 collects, stores and analyzes status and operational information relating to each lottery terminal unit 104. For example, the lottery network computer 106 may continuously receive transactional data from the individual lottery terminal unit 104 indicative of voting information such as voter identification data and voter selections received at each lottery terminal unit. The transactional data collected by the lottery network computer 106 may be communicated to the host computer system 124 continuously or may be processed into a batch format and transmitted periodically for storage in the database 154. If, for example, the central election controller 136 and the lottery network computer 106 are communicating continuously, it may be desirable for the central election controller 136 to execute the actual election/voting routine and transmit the processing instructions and related data to the lottery network computer 106 for distribution to the lottery terminal units 104 and directly to the lottery terminal units 116. In addition, it may be desirable for the central election controller 136 to include, via the peripheral device input 152 (e.g., a scanner), functionality for directly importing/reading manual selections into the database 154.

FIG. 1 further provides a block diagram of selected portions of one possible embodiment of a lottery terminal unit 104. Although the following description relates to the design of the lottery terminal unit 104 depicted in FIG. 1, it should be understood that the lottery terminal units 104 and 116 may include similar features or may be configured with functionality to allow the entry of the information required for both participation in lottery games and/or elections. The exemplary lottery terminal unit 104 may include a number of internal components such as a controller 200 having a program memory 202, a microcontroller or microprocessor (MP) 204, a random access memory (RAM) 206, and an input/output (I/O) bus 208, all of which may be interconnected via an address or data bus 210. It should be understood that while only one microprocessor 204 is shown herein, the controller 200 may be designed to support multiple microprocessors 204 arranged to operate in parallel or in any other known configuration. Similarly, the controller 200 may include multiple, and even redundant, program memories 202 and random access memories 206 to increase expandability, capacity and/or processing speed.

The multiple processor and memory configurations may be used, for example, to isolate the individual lottery functions such as basic lottery operation, random number generation, information tracking, and the like from various voting functions such as voter identification, tracking of voter selections, and more. Although the I/O bus 208 is shown as a single addressable and integral block, it should be understood that direct I/O connections may be made, as well as any other desired I/O connection scheme.

The program memory 202 and random access memory 206 may be implemented as a solid-state memory, an integrated circuit, a magnetically readable memory, and/or optically readable memories. Further, the program memory 202 may be read only memory (ROM) or may be read/write memory such as a hard disk. In the event that a hard disk is used as the program memory, the data bus 210 may comprise multiple address/data buses, which may be of differing types, and there may be a separate I/O circuit between the data buses.

Both memory units 202, 206 can generally be considered as data stores, which may be selectively employed to implement voting functionality in accordance with aspects of the present technology. For example, program memory 202 may be used to store software in the form of computer-readable instructions and executable instructions that are configured to program the controller 200 as a special purpose computing device to perform various algorithmic steps. Memory 206 or other data store may be configured to temporarily or permanently store input and other electronic data received from a user/voter.

Referring still to FIG. 1, the lottery terminal units 104, 116 and lottery nodes 120 may include centralized or shared display mechanisms such as a scrolling digital signs or message boards configured to display various information to a user. When terminal units are used for lottery or gaming purposes, the outcome of a completed lottery game or messages that advertise or attract players to upcoming games may be displayed. In other instances, such as on election day(s), or when a terminal unit is selected or toggled for voting functionality, such display mechanisms can be used to advertise availability as a polling location, for displaying running vote totals or percentages for certain candidates, issues, etc., or for other election-related purposes. In one exemplary configuration, at least one terminal unit 104 or 116 includes software for generating graphics and is communicatively connected to an external LCD suitable for displaying graphics. Upon completion of an individual vote, an entire election, or other election-related event, the results can be formatted by the graphical software and displayed, in an eye-catching manner, on the external LCD. Alternatively, the graphical software may be stored on a peripheral device, such as a CD-ROM, and the result of the election information communicated thereto for formatting and display.

It will be understood that the lottery network 100 illustrated in FIG. 1 may alternatively represent the network layout within a given establishment. In this alternate configuration, each stand-alone lottery terminal unit 104 may be an interactive terminal capable of playing a variety of lottery or casino games, such as a lottery game, Keno, Bingo, video poker, video blackjack, slots, and the like. If a given establishment is authorized for operation as a polling location for elections, then each such lottery terminal unit could be provided with hardware components and software functionality for operation as a respective voting booth. Terminal units 104 may be distributed throughout a single establishment and connected with a LAN, or throughout multiple sites and connected with a WAN. Further, the LAN and/or WAN connecting each of the terminal units 104 may include one or more separate and secure buses 108, routers 112, web servers, gateways and other networking equipment to provide continuous and/or redundant connectivity to the network 110. As discussed above, the network 110 may be communicatively connected to central host computers 122 and/or 124, and respective central lottery and election controllers as well as associated databases to allow for implementation, storage, tracking and analysis of gaming and lottery features.

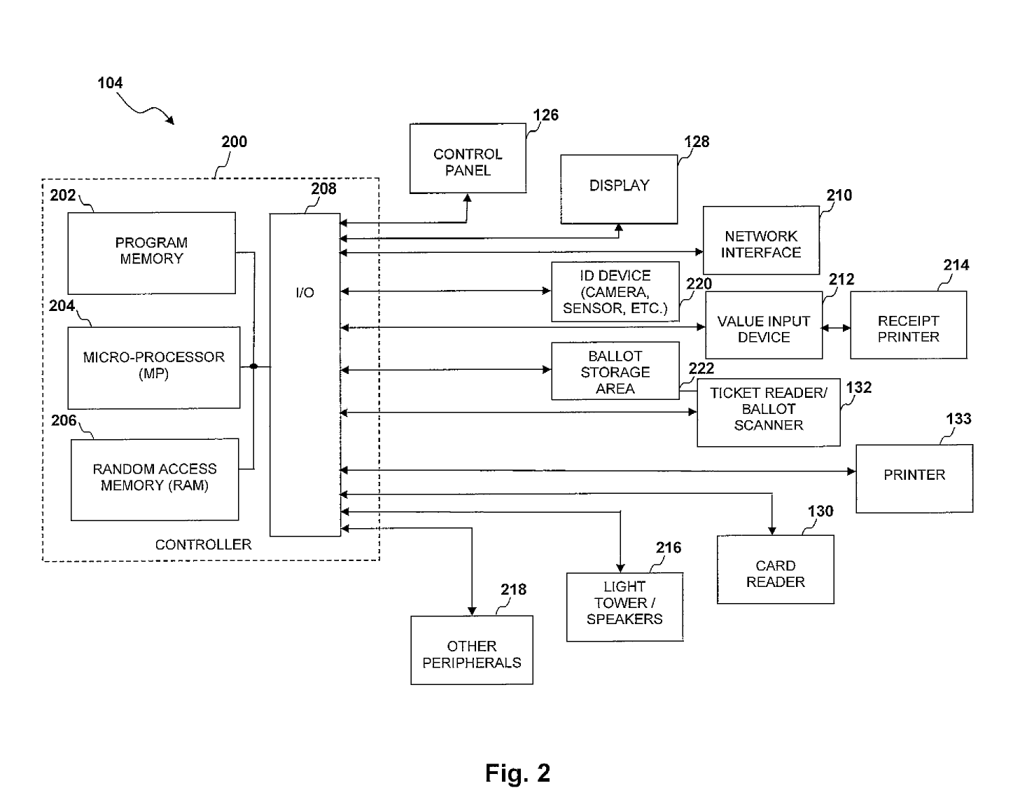

More particular aspects of a terminal unit (capable of operation as both a gaming mechanism and a voting mechanism) will now be discussed with reference to FIG. 2. It should be appreciated that features or functionality described with reference to terminal unit 104 may equally apply to selected others of terminal units 116, terminal nodes 120, or others. FIG. 2 schematically illustrates that the terminal unit controller 200 may be communicatively connected to a plurality of components, some or all of which may be physically integrated with controller 200 in a given housing or casing (not shown), or which may alternatively be selectively provided as separate physical components having operational and communicative connection to controller 200. Coupled components may include one or more of the following: control panel 126, display 128, card reader 130, ticket reader/ballot scanner 132, ticket/ballot confirmation receipt printer 133, network interface 210, value input device 212 and monetary receipt printer 214, identification device(s) 220 such as a camera, sensor, or the like, ballot storage area 222, visual and audio output (e.g., light tower/speakers) 216, and other peripherals 218.

FIG. 2 illustrates the various coupled components listed above as directly connected to the I/O bus 208 via dedicated circuits or conductors. However, it will be understood that different connections schemes may be used. For example, some of the components requiring limited communications with the controller 200 may be communicated via an auxiliary I/O bus (not shown) in a scheduled manner, while other components requiring fast communications or large data transfers may be directly connected to the I/O bus 208. Furthermore, depending on the needs of the system, some of the components may be directly connected to the microprocessor 204 without having to pass through the I/O bus 208.

Referring still to FIG. 2, control panel 126 may correspond to one or more input devices for receiving input from a user. For example, control panel 126 may correspond to a keyboard with input keys, mouse with input buttons, touch-screen with graphical user interface, joystick, microphone, or other peripheral. When terminal unit 104 is operated as a gaming mechanism, such input features may allow a game or lottery player (or sales agent) to select the game to be played, input the value to be wagered, manually enter the selected lottery characters, and input any other information necessary to play a given lottery game. When terminal unit 104 is used as a voting mechanism, the input features allow a voter to perform such tasks as providing initial information such as unique voter identification numbers, making voting selections for desired candidates, officials, questions, issues, etc., and providing confirmation of voting selections. The input features may also accommodate input from others who may be present to oversee aspects of the voting process, such as authorities present to verify identity of voters, activate or selectively control operation of the terminal as a voting mechanism as opposed to a gaming mechanism, or other associated tasks.

Another type of input device corresponds to the reader/scanner 132. In one embodiment, the same reader/scanner 132 is capable of receiving and processing gaming play slips, lottery tickets, and voting ballots. In other embodiments, one or more separate devices may be provided for each type of respective input. When reader/scanner 132 functions as a ballot scanner to receive a ballot from a voter, it is capable of determining from the physical ballot what information is selected or provided by a voter. As appreciated by one of ordinary skill in the art, a scanner may employ optical devices to capture or process images detected from the ballot and convert the image information into related data selections. Reader/scanner 132 may be configured to read bar codes, user selections, magnetically stored information or any other desired input information or media used to encode information on a ballot. A processor either associated with the reader/scanner 132 or with controller 200 is programmed to execute software instructions for correlating the information received from a voter via an inputted ballot into electronic data for subsequent storage in one or more memory locations or databases provided either locally or at a separate or central location.

A ballot storage area 222 may be directly or indirectly physically linked to the reader/scanner 132 to provide a physical location for storage of some or all ballots received at the terminal unit 104. Storing all received ballots at the terminal unit helps establish a paper trail for subsequent collection by a voting authority. Additional information that may be inserted into the reader/scanner 132 and/or stored in the storage area 222 may correspond to correct or incorrect confirmation voting receipts provided for a user. For example, it may also be desired to prompt a user to provide and store incorrect receipts to evidence the incorrect information and confirm that subsequent correction was made before a final vote was processed. In one embodiment, as long as voting receipts contain correct information, such correct receipts may be retained by the voter.

Additional optional input devices provided at terminal unit 104 may correspond to one or more identification devices 220. Such identification devices may be desired to provide additional verification or confirmation of a voter's identity than the mere provision of a unique voter identification variable located as a barcode or identifier on a ballot or provided as input by a user via the control panel 126, touch screen display 128 or the like. One example of a voter identification device 220 corresponds to a digital (still or video) camera or other image capture component for obtaining a picture or video of each voter using the terminal unit 104 as a voting mechanism. Another example corresponds to a biometric sensor configured to obtain information identified for automated recognition/verification of individuals based on one or more of their biological or behavioral traits. One example of a biometric sensor corresponds to a fingerprint scanner, although other devices may be used to capture information associated with such personal traits or features as the face, iris, palmprint, retina, hand geometry, voice, signature, or others associated with a voter. Card reader 130 may also be configured to receive voter identification information, such as confirmation obtainable from a card such as a driver's license, passport, credit card, identification card, or other item.

The display 128 may be a LCD, a CRT, a touch-screen capable of receiving and displaying information, or any other suitable device capable of displaying the information input via the control panel 126, the reader/scanner 132 or the touch-screen input. Display 128 may be used as an output device to visually display voter selections to a voter so that they can review the selections and either confirm them or request to make changes to the selections before subsequent confirmation. When display 128 corresponds to a touch-screen, it effectively functions as both an input and an output device.

Terminal unit 104 may further include a value input device 212 that can accept value or a wager from a customer, such as from an optical currency collector, or from card reader 130 when such card reader is configured to accept credit cards, gift cards, or the like. The value input device 212 may further be integrated with external devices, such as cash registers or other retail terminals, communicatively connected to the lottery terminal unit 104, to exchange information necessary to receive and record the wagering transactions. For example, value input device 212 may be coupled with a receipt printer 214 for providing a value receipt to a user when monies or credits are exchanged. In instances where terminal unit 104 is operating as a voting mechanism, the terminal unit may selectively disable value input device 212 and related peripherals if no fees are to be charged for the voting process. The controller 200 may operate to perform such disabling function, if desired, upon instruction received from a central location or alternatively from a local authority present at the terminal unit, related node or server, automatically upon receipt of a scanned ballot from a voter or upon an input received from a voter via control panel 126, or upon some other triggering event.

Referring still to FIG. 2, the printer 133 may provide different functions depending on whether the terminal unit is used as a gaming mechanism or a voting mechanism. For example, when operating as a gaming mechanism, printer 133 may be used to print or otherwise encode lottery tickets with information selected or required to play a given lottery game. Further, the printer 133 may provide lottery tickets, or even completed lottery slips if the selections were generated automatically, that could be used by the player in other lottery terminal units 116 equipped with lottery play slip or ticker readers 132. When operating as a voting mechanism, printer 133 may be used to print receipts providing voter information including voter selections. These receipts can be used to confirm the accuracy of voter selections, or if confirmation is obtained in other ways the receipt can function simply to provide a paper trail for the voter. It should be noted that although only a single printer is shown in FIG. 2, different printers could be provided for different functions. For example, one printer for lottery and gaming tickets could be provided and another for voter confirmation receipts.

The network interface card 210 may be configured to allow the terminal unit 104 to communicate information with other networked devices similarly connected to the network 110 using any known protocol or standard suitable for a network application. The light tower and speaker link 216 may be used to integrate visual and/or audio displays into the design of the terminal unit 104. Additional peripherals 218 to supplement or enhance the operation of terminal unit 104 as a gaming mechanism and/or a voting mechanism may be included as desired.

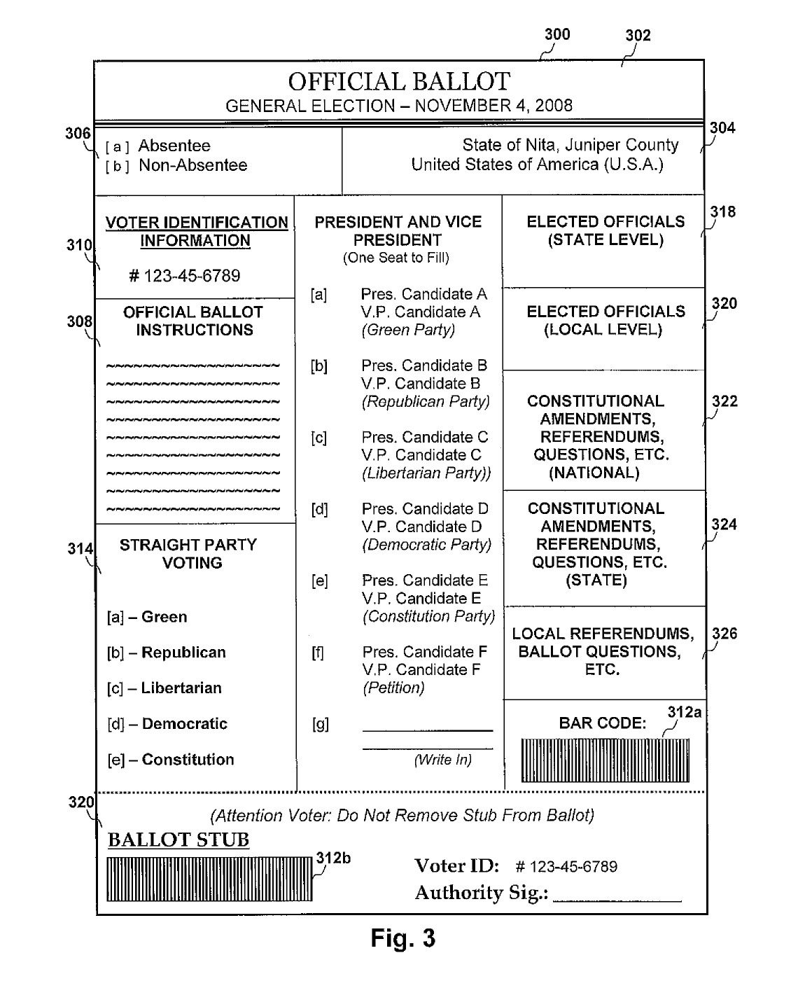

Referring now to FIG. 3, an exemplary ballot 300 is illustrated. The distribution of ballots to registered voters can be accomplished in any variety of fashions. For example, ballots could be general for completion and use by any voter. In another example, ballots have a unique ID or other identifying parameter associated with each voter. In such cases, ballots might be printed by the government or designated voting authority for each registered voter and mailed to the voter. It may be desirable to implement still further security measures in accordance with a ballot distribution arrangement. Other distribution schemes are also within the scope of the present invention.

A ballot 300 may be composed of paper, Mylar, cardboard or any other suitable printable or encodable material. The ballot 300 may include informational, instructional or security information such as a bar code, voter identification information, voter instructions for making selections, or any other desired information. Although the exemplary representation in FIG. 3 shows ballot 300 as a single sheet with information only the front of a ballot, it should be appreciated that a ballot could consist of multiple pages or portions of material and information could be provided on front and/or back sides of such pages or portions.

Ballot 300 as shown in FIG. 3 is provided in a predetermined format with multiple different sections of information, with selected sections containing locations by which a voter may designate his/her desired voter selections for various elected officials, amendments, issues, questions, or other selectable items. A voter may be instructed to make his/her selections in accordance with a predetermined type of indication. For example, selection options (e.g., those represented on ballot 300 as options [a], [b], [c], [d], [e], etc.) can have corresponding circles to be bubbled, boxes to be checked, lines to be marked, chads or holes to be punched, or selections to be highlighted, circled, or selected by any other manner of designation. Ballot 300 may be printed with any optically readable material such as ink, or encoded with data on a magnetic material, smart chip or other media for encoding data. Ballot 300 and the corresponding voter selections are ultimately provided as input to a terminal unit. A controller associated with each terminal unit may be preprogrammed with software instructions corresponding to the designated manner(s) of selection so that the terminal unit controller and associated devices (e.g., ballot scanner) are programmed to scan ballot 300, detect the user selections according to configured algorithms, and convert the detected information into data for subsequent storage.

Referring still to FIG. 3, exemplary ballot 300 may be configured in a variety of formats, types or styles without being unnecessarily limiting to the scope of the present invention. In one example, ballot 300 includes general categories of information, including but not limited to instructional information, identification information, selection information (for designating actual voting selections), authorization information, and the like.

Exemplary instructional information provided on ballot 300 may include a header section 302, jurisdiction section 304, ballot type section 306, and/or ballot instruction section 308. Ballot 300 may include a header section 302 for providing general information indicating that a ballot is an official voting form for a designated election on a designated date or dates. When a ballot is used to vote for officials or on issues affecting a variety of different jurisdictions, the particular groups or subgroups of jurisdictions may also be identified by a jurisdiction section 304. In one example, jurisdiction section 304 identifies the country, state and county in which the voter is registered. A ballot type section 306 may be provided to designate type, for example if a ballot will be used for absentee voting, non-absentee voting, or other appropriate type. Official ballot instruction section 308 may provide instructions for how a voter is to complete the ballot 300, including how to make vote selections. Additional instructions may describe certain candidates or issues contained on the ballot, identify when and where to cast the ballots (by taking them to one or more designated lottery terminal units in accordance with aspects of the present invention), or provide still further information as desired for a particular election, jurisdiction, etc.

Identification information may be provided in the form of a voter identification section 310 and barcodes 312a and 312b. More particularly, ballot 300 may include a voter identification section 310 to provide a unique voter identification number, alphanumeric representation, or other predetermined variable(s) to uniquely associate each registered voter with his/her ballot. Exemplary voter identification numbers could correspond to a one-time unique, personal identification number, driver's license or passport number, social security number or other number. Additionally or alternatively, a barcode section 312 (which may be duplicated as represented by sections 312a and 312b in FIG. 3) may be provided for unique identification information.

At the time of voting, it may be desired to verify that the person presenting the ballot 300 at a terminal is actually the registered voter the ballot is intended for. In this regard, the voter may be required to provide an independent identification source to a peripheral device associated with the terminal, such as a picture, bio-scan, fingerprint, etc., that can be cross-referenced via the computer system 124 with any manner of independent database to verify that the person presenting the ballot 300 is the person uniquely associated with the voter identification information provided on the ballot 300, as discussed more fully below.

Ballot 300 may contain selection information corresponding to the portions of a ballot by which a user may identify his selections for elected officials, issues, or the like. For example, a straight party voting section 314 may be provided by which a voter can indicate with a single selection, for example one of identified party choices such as but not limited to Green, Republican, Libertarian, Democratic, Constitution, or other parties, that he/she desires to vote for all candidates of a particular party designation. An exemplary selection portion 316 may provide options for a voter to select desired candidates for elected positions on the national level. In a presidential election, selection information is provided for a voter to select a Presidential and Vice Presidential candidate from provided choices or as a write-in candidate. Additional candidates on the national level may correspond to options for U.S. Senate and/or the U.S. House of Representatives. Selection section 318 may be provided for selecting elected officials on the state level, such as but not limited to governor, state senator, representative for the state house, etc. Selection section 320 may be provided for selecting elected officials on the local level, such as but not limited to county officials, town or municipal officials, and the like—e.g., sheriff, mayor, clerk of court, register of deeds, coroner, city council, school board official, and others. One or more selection sections 322, 324 and 326 may be provided to respectively vote on selected national, state or local issues such as but not limited to constitutional amendments, referendums, certified questions, or others. Still further selection sections for officials, issues, or other items may be provided, and it should be appreciated that each of one or more selection sections may be configured with predetermined options and/or with write-in locations for identifying selections. The ballot 300 is shown as an example only and should not be unduly limiting to the present invention.

Ballot 300 may also optionally include a stub portion 330, which may be provided as scanned input to a terminal unit in accordance with the present technology, retained by an authorized official at one or more terminal unit locations, retained by the voter at the time of casting his/her ballot, or otherwise handled in a desired fashion. In one example, stub portion 330 includes duplicate voter identification information such as the unique ID number provided in section 310 and bar code 312b. A location may be provided for signature or initials of an authorizing agent, for example an authority who assisted with distributing ballots before the election or who assisted with overseeing vote collection at the terminal unit locations.

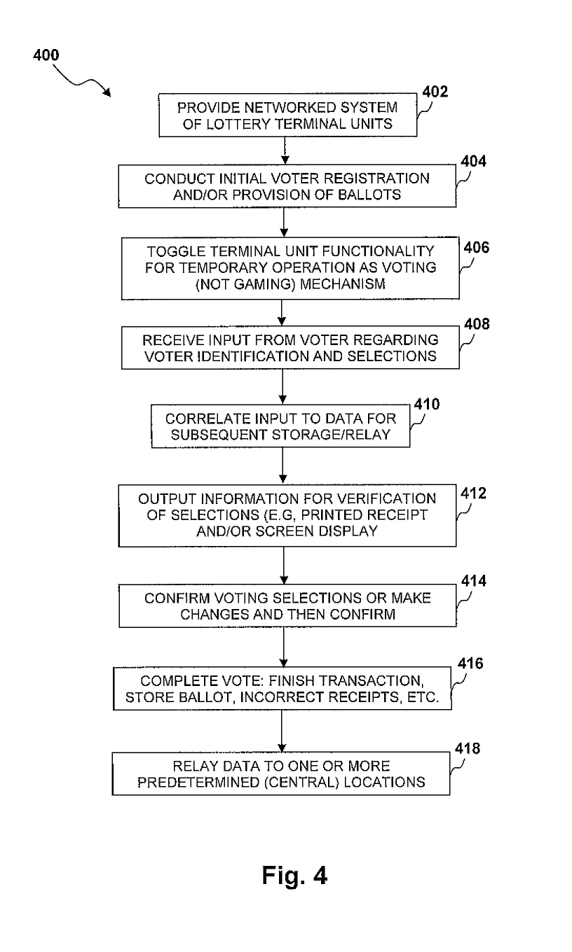

Exemplary functions and steps associated with methodology of the present invention will now be presented with reference to FIG. 4, with particular application to processing of voter information at terminal units such as depicted in FIGS. 1 and 2. FIG. 4 displays steps which may be selectively implemented in accordance with a method 400 of conducting elections using a networked system of lottery terminal units. In the example of FIG. 4, a first initial step 402 corresponds to providing a networked system of lottery terminal units, such as illustrated and described with reference to FIGS. 1 and 2. The lottery terminal units are all communicatively coupled to one or more predetermined (central) locations so that voting information received at the terminal units can be relayed for subsequent compilation, processing, analysis, and the like. As previously described, each of the networked lottery terminal units provided in step 402 can include one or more input devices for receiving input from a voter, authority, or other user entities as well as one or more output devices for providing displays, receipts, or other output to a user.

Another initial step 404 involves conducting voter registration and/or providing ballots to a user. In one embodiment, voter registration is conducted according to known processes, by which a voter can provide required information online at one or more designated websites, at a post office, department of motor vehicles, local agency, or other designated locations in advance of an election date. In another embodiment, lottery terminal units are connected to the Internet and configured to receive and process voter registration information at some point prior to or concurrent with the ballot casting process described more particularly herein. When lottery terminal units are configured to implement voter registration, a user inputs required identification information, such as name, address including state and/or county, driver's license number, social security number, location to which ballot will be mailed, etc. Selected portions of the provided information may then be relayed to one or more registration processing centers (e.g., on the county, state or national level) for processing or verification of registered voters and subsequent processing and mailing of voter ballots. In one example, voter registration follows with each registered voter being provided a ballot, for example the ballot 300 shown in FIG. 3. Such ballots may include information such as instructional and voter identification information, as well as locations by which a voter can designate voter selection(s) for various elected officials, designated issues, or other items.

An additional optional step 406 corresponds to the toggling of a terminal unit for temporary functionality as a voting mechanism. When lottery terminal units are more often used as gaming mechanisms, such a toggling step may be desired so that the terminal unit can be implemented to function in a desired fashion. For example, the terminal unit may execute software instructions initiating the terminal unit to waive payments that might be required when the unit is operated as a gaming mechanism, display different or additional information related to voting as opposed to gaming, or other steps as programmed in a toggling algorithm. The exemplary toggling step 406 may be implemented in a variety of fashions. For example, toggling step 406 may initiate automatically upon receipt of a ballot 300 into a ballot scanner associated with a terminal unit. In another example, toggling step 406 may be initiated by user selection of a voting option provided at a control panel or touch screen at the terminal unit. In a still further example, toggling step 406 occurs when a remote controller signal or a local input is received from an authority to activate the terminal unit for operation as a voting mechanism.

Next step 408 generally involves receiving input from a voter regarding at least one voter identification variable and at least one voter selection. As previously discussed, voter identification information may correspond to the unique voter ID number or unique bar code provided on a voter ballot. Voter identification information may be provided to a terminal unit by such devices as a control panel, card reader, camera, biometric sensor of other device. For example, identification numbers or variables can be manually entered by a user via the control panel. A driver's license, credit card, or other ID card may be provided to a card reader associated with the terminal unit. A camera (e.g., webcam, digital camera, etc.) provided at the terminal unit may capture a photo or video image of the voter for additional confirmation and verification. Biometric sensors such as fingerprint, hand, palm, retina, or facial scanners or devices for capturing voice or signatures may also be provided for obtaining identification input from a user. Any one or combination of characteristics from the person presenting the ballot at the terminal may be used by the central computer system to verify that such person is the registered voter associated with the unique identification information on the ballot. Voter selection information generally corresponds to a voter's choices in the election and may be received from a user in the form of the voter's ballot (where selections are indicated thereon) or from manual selection by the user of choices displayed on a screen or other output device.

Step 410 involves the correlation of input received from a user into data for subsequent storage and relay. When data received from a user is in the form of a scanned ballot, step 410 may involve the terminal unit controller executing software instructions stored in memory which specially configure the terminal unit to detect information on the scanned ballot (e.g., via optical, magnetic, or other detection technology) and convert such information into electronic data. The electronic data corresponding to voter selections (and associated voter identification) may be stored locally or at a separate peripheral or central location. The electronic data may additionally or alternatively be electronically communicated via a network at this point in the method or at a later point (e.g., at step 418).

Referring now to step 412 of FIG. 4, information may be provided as output to a user so that the user can confirm the accuracy of the electronic data captured in step 408 and correlated in step 410. For example, information may be displayed to a user on a display device associated with a terminal unit or may be provided as a printed receipt. The output information may correspond to selected portions of the input information, and may particularly include some or all of the voter selections. A user can then review the output information. If the output information is correct, the user can confirm his/her selections in step 414 by selecting a confirmation option on a control panel or touch screen provided at the terminal unit. If the output information is incorrect, or if a user desires to change his/her voter selections, a control panel may be provided with a user interface allowing the user to change one or more of his/her voter selections. Additional outputs may be provided for confirmation and subsequent selection after selections are changed. In one example, the terminal unit may prompt the user to insert incorrect receipts as evidence of changed voter selections to help confirm accuracy of the voting process.

Exemplary step 416 corresponds to completion of the voting transaction. In one example, step 416 may function to close out the voting screen on the terminal unit and provide a message to the user thanking him/her for the vote or providing other conclusory information. Completion step 416 may also function to physically transfer a scanned ballot, incorrect receipts, or other information to a physical storage area within the terminal unit. It should be appreciated that this physical transfer of paper items may alternatively occur at a different point in the method 400.

Step 418 may also involve aspects involved with completion of a voting transaction, by automatically signaling the terminal unit to relay data to one or more predetermined locations. For example, upon completion of each voter transaction, a terminal unit can relay voter identification and selection information for national candidates and issues to a first central location corresponding to a designated headquarters for processing of national election results. Similarly, a terminal unit can relay voter identification and selection information for state candidates and issues to a second central location corresponding to a designated headquarters for processing of state election results. Still further, a terminal unit can relay information for local candidates and issues to a third central location corresponding to designated headquarters for county, city, or other local election results. All voter identification information and selections or only selected portions of such information may be sent to one or more of such predetermined central locations. Although not depicted in FIG. 4, additional steps may involve the tabulation of voting results in real-time as new voting data is received from the networked terminal units, or generation of reports including running totals of vote status.

It should be appreciated that the exemplary steps described above with reference to FIG. 4 may be selectively chosen, performed in different orders, or supplemented or replaced by related variations as understood from the present disclosure to yield still further exemplary embodiments of a method for conducting elections using a networked system of lottery terminal units.

The material particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

What is claimed is:

1. A method of conducting elections using a networked system of lottery terminal units, said method comprising:
providing a networked system of lottery terminals units;
receiving input from a voter at one of the lottery terminal units, said input including at least one voter selection and a unique voter identification variable;
electronically capturing the received voter input into a local data store;
outputting information to the voter corresponding to selected portions of the voter input for subsequent confirmation of accuracy of the at least one voter selection; and
electronically communicating selected portions of the received voter input to at least one networked central location.

2. The method of claim 1, further comprising a step of toggling the functionality of selected lottery terminal units to operate as voting mechanisms as opposed to gaming mechanisms.

3. The method of claim 2, wherein said step of toggling the functionality of selected lottery terminal units to operate a voting mechanisms comprises receiving an electronic signal from a voter.

4. The method of claim 1, wherein said step of receiving input from a voter comprises:
scanning a ballot provided by the voter to one of the lottery terminal units; and
executing software instructions configured to correlate information detected from the scanned ballot into electronic data for subsequent download to the local data store.

5. The method of claim 4, further comprising a step of toggling the functionality of a lottery terminal unit to operate as a voting mechanism, whereby said toggling step comprises automatically executing software instructions upon receipt of a scanned ballot from a voter.

6. The method of claim 4, further comprising a step of physically storing the ballot scanned at the lottery terminal unit.

7. The method of claim 1, further comprising a step of receiving as input an electronic signal representative of authorization from a voting official to proceed with processing of a given voter's ballot.

8. The method of claim 1, further comprising a step of electronically capturing and storing voter identification information in addition to the at least one unique voter identification variable.

9. The method of claim 8, wherein said step of electronically capturing and storing voter identification information in addition to the at least one unique voter identification variable comprises using a biometric sensor to obtain such voter identification information.

10. The method of claim 8, wherein said step of electronically capturing and storing voter identification information in addition to the at least one unique voter identification variable comprises using a digital camera to electronically obtain a visual representation of the voter present at the lottery terminal unit.

11. The method of claim 1, wherein said step of outputting information to the voter corresponding to selected portions of the voter input for subsequent confirmation of accuracy of the at least one voter selection comprises providing a visual screenshot to a user.

12. The method of claim 1, wherein said step of outputting information to the voter corresponding to selected portions of the voter input for subsequent confirmation of accuracy of the at least one voter selection comprises providing a printed receipt to a user.

13. The method of claim 1, further comprising receiving electronic signals from a user representative of confirmation of accuracy of the outputted information or of desired changes to the at least one voter selection.

14. The method of claim 1, wherein said step of electronically communicating the received voter input to at least one networked central location occurs automatically upon receipt of electronic information from each voter accessing the lottery terminal unit.

15. The method of claim 1, wherein said step of electronically communicating the received voter input to at least one networked central location comprises electronically communicating selected received voter input to a first central location, and electronically communicating selected received voter input to a second different central location.

16. A lottery terminal, comprising:
an input device configured to receive information from a user, said information being representative of initial voting input data from the user;
a terminal controller operatively coupled to said input device, said terminal controller comprising a processor and a memory operatively coupled to said processor;
an output device for providing information to the user; and
a network interface for communicatively coupling said lottery terminal to a network;
wherein said memory comprises computer-readable instructions accessible by said processor for programming said terminal controller to process the initial voting input data received from the user and store as electronic data.

17. The lottery terminal unit of claim 16, wherein said memory further comprises computer-readable instructions accessible by said processor for programming said terminal controller to allow a user to provide gaming data as input to the terminal unit.

18. The lottery terminal unit of claim 17, wherein said memory further comprises computer-readable instructions accessible by said processor for programming said terminal controller for functional processing of voting data as opposed to gaming data.

19. The lottery terminal unit of claim 16, wherein said input device comprises a ballot scanner.

20. The lottery terminal unit of claim 19, wherein said memory further comprises computer-readable instructions accessible by said processor for programming said terminal controller to correlate information detected from a ballot entered into said ballot scanner into electronic data for subsequent electronic storage.

21. The lottery terminal unit of claim 19, further comprising an enclosed and secure storage area coupled to said ballot scanner for receiving and securely storing scanned ballots input to the lottery terminal unit.

22. The lottery terminal unit of claim 16, wherein said input device comprises an electronic peripheral configured to receive information from a user which is converted into electronic data for subsequent electronic storage, the received information comprising the information representative of initial voting input data.

23. The lottery terminal unit of claim 22, wherein the received information from the user further comprises confirmation of accuracy of the selected portions of the initial voting input data or of desired changes to selected portions of the initial voting input data.

24. The lottery terminal unit of claim 23, wherein said memory further comprises computer-readable instructions accessible by said processor for programming said terminal controller to automatically relay selected portions of the initial voting input data via said network interface upon receipt of confirmation of accuracy from the user via said electronic peripheral.

25. The lottery terminal unit of claim 16, wherein said output device comprises a display screen for visually displaying selected information to the user.

26. The lottery terminal unit of claim 16, wherein said output device comprises a printer for printing a receipt for the user.

27. The lottery terminal unit of claim 16, further comprising a biometric sensor for obtaining user recognition or verification information.

28. The lottery terminal unit of claim 16, further comprising a digital camera for obtaining a picture or video image of the at least one user.

29. The lottery terminal unit of claim 16, wherein said memory further comprises computer-readable instructions accessible by said processor for programming said terminal controller to communicate selected received voter input data to a first predetermined location via said network interface, and to communicate selected received voter input data to a second different predetermined location via said network interface.

30. A lottery gaming system configured to selectively function as a voting system, comprising:
a plurality of terminal units, each terminal unit comprising:
an input device configured to receive information from a user, said information being representative of initial voting input data from the user;
a terminal controller operatively coupled to said input device, said terminal controller comprising a processor and a memory operatively coupled to said processor;
an output device for providing information to the user; and
a network interface for communicatively coupling said lottery terminal to a network;
wherein said memory comprises computer-readable instructions accessible by said processor for programming said terminal controller to (i) toggle between functional processing of voting data and gaming data; and (ii) process the initial voting input data received from the user and store as electronic data.
